(19) United States
(12) Patent Application Publication
(10) Pub. No.: US 2026/0338597 A1
(43) Pub. Date: Oct. 29, 2026

(54) Reduced Noise In High-Bandwidth, Low-Power Photodetectors

(71) Applicant: Tectus Corporation, Cupertino, CA (US)

(72) Inventors: Cary Loren Delano, Los Altos, CA (US); Brent Douglas Delano, Los Altos, CA (US); Michael West Wiemer, San Jose, CA (US)

(21) Appl. No.: 19/658,311

(22) Filed: Apr. 24, 2026

Related U.S. Application Data
(60) Provisional application No. 63/794,233, filed on Apr. 24, 2025.

(51) Int. Cl. G01J 1/44

(52) U.S. Cl. CPC G01J 1/44; G01J 2001/446

(57) ABSTRACT

A circuit includes a split photodiode and a transimpedance amplifier (TIA). The split photodiode contains two segments with a single combined output. The TIA is coupled to the combined output of the segments. The TIA is supplied by a DC voltage source. The circuit also includes AC coupling of the DC voltage source to the split photodiode. As a result, the AC coupling superimposes an AC signal from the DC voltage source on the combined output of the segments of the split photodiode.

### CROSS-REFERENCE TO RELATED APPLICATION(S)

This application claims priority under 35 U.S.C. § 119(e) to U.S. Provisional Patent Application Ser. No. 63/794,233, “Reduced Noise in High-Bandwidth, Low-Power Photodetectors,” filed Apr. 24, 2025. The subject matter of all of the foregoing is incorporated herein by reference in its entirety.

### BACKGROUND

Finite communication speeds between data sources and sinks limit modern computing performance. In AI data centers, for example, data transfer rates between graphics processing units (GPUs) and high-bandwidth memory (HBM) are a bottleneck. Optical chip-to-chip interconnects offer a potential solution. Optical interconnects have significant advantages over electrical interconnects including higher bandwidth, no need for electronic channel equalization, and lighter weight.

High-bandwidth, low-power photodetector systems are useful for converting optical signals to electrical signals in high-speed fiber-optic communications, such as in chip-to-chip optical interconnects in AI data centers.

### BRIEF DESCRIPTION OF THE DRAWINGS

FIG. 1A (prior art) illustrates a top view of a single photodetector defined on a section of a semiconductor wafer.

FIG. 1B (prior art) is a simplified schematic diagram for a circuit associated with the single photodetector of FIG. 1A.

FIG. 2A illustrates a top view of a split photodetector defined on a section of a semiconductor wafer.

FIG. 2B is a simplified schematic diagram for a circuit associated with the split photodetector of FIG. 2A.

FIG. 2C is a simplified schematic diagram for an alternative circuit associated with the split photodetector of FIG. 2A.

FIG. 3A illustrates a photodetector connected to a first implementation of a transimpedance amplifier.

FIG. 3B illustrates a photodetector connected to a second implementation of a transimpedance amplifier.

FIG. 4A is an eye-diagram illustrating performance achieved with the single photodetector of FIG. 1A and its associated circuit of FIG. 1B.

FIG. 4B is an eye-diagram illustrating performance achieved with the split photodetector of FIG. 2A and its associated circuit of FIG. 2B.

FIG. 5A shows a cross-section of an integrated optical transceiver for chip-to-chip communication.

FIG. 5B is a block diagram of the integrated optical transceiver of FIG. 5A.

FIG. 6 shows a cross-section of another integrated optical transceiver with a three-layer stack.

FIG. 7 shows a cross-section of an integrated optical transceiver with a two-layer stack.

### DETAILED DESCRIPTION

When a weak, digitally modulated (e.g. on/off) optical signal is incident on a photodetector, noise in subsequent amplification stages may lead to errors, such as a digital “1” being output as a “0” or vice versa. The problem arises because noise in the nominally DC amplifier power supply, V_{dd}, couples into the amplifiers' bias points. The problem is more critical in arrays of transimpedance amplifiers (TIAs) where power supply variations at one TIA, or other circuitry on the same power supply rail, may influence adjacent TIAs.

A photodetector may be connected to a transimpedance amplifier (TIA) as the first stage of gain. Some transimpedance amplifier designs offer low power consumption, but poor power supply rejection ratio, PSRR. Other designs offer good PSRR at the expense of higher power consumption. All TIA are subject to design specifications for achievable PSRR.

Good PSRR and low power consumption may be obtained simultaneously by introducing a split photodetector and injecting the AC noise component of the TIA DC power supply, V_{dd}, into the photodetector. This makes the photodetector output fluctuate synchronously with variations in the bias point or input threshold of the TIA caused by the AC noise in the amplifier's DC supply, thus reducing the effect of the AC noise.

A split photodetector is split into two (or more) parts or segments. The areas of the segments of the photodetector need not be the same size. In fact, their areas (and therefore capacitances) may be adjusted to obtain the desired fraction of the noise component of V_{dd} at the input to the transimpedance amplifier (TIA). In one approach, if there were no parasitic capacitances, and the TIA input bias variation were proportional to V_{dd}/2, then the segments of the split photodetector would be designed with equal areas and one-half of the noise component of V_{dd} would be input to the TIA. In general, a set of optimal sizes for the photodetector segments exists which leads to optimal improvement in PSRR for the TIA.

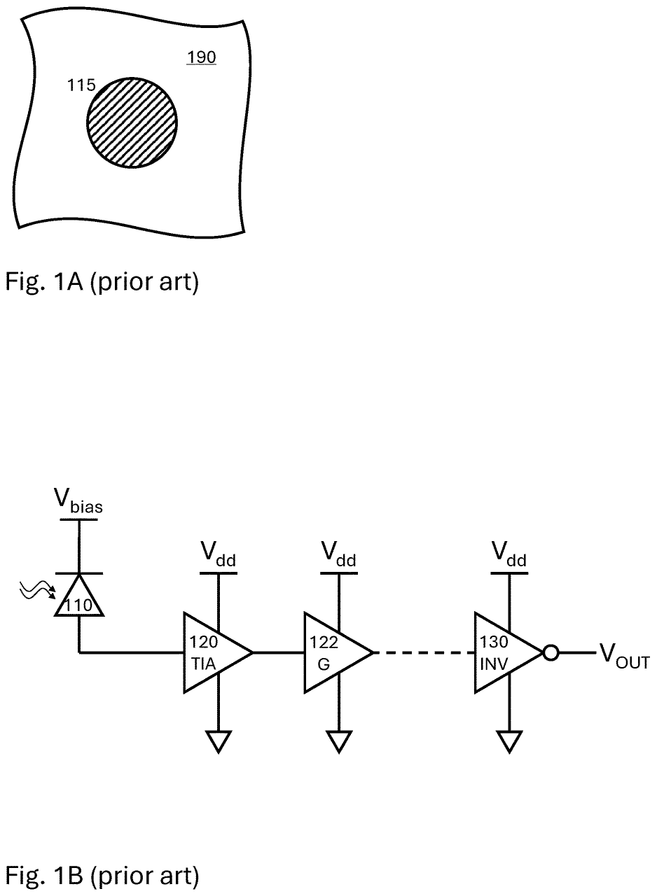

Turning now to the figures, FIG. 1A (prior art) illustrates a top view of a single photodetector defined on a section of a semiconductor wafer 190. The cross-hatched area 115 in FIG. 1A is the light-sensitive area of the photodetector. Such a photodetector may be one element of a large array of photodetectors. FIG. 1B (prior art) is a simplified schematic diagram for a circuit associated with the single photodetector of FIG. 1A. In FIG. 1B, current is supplied to a photodetector from a bias supply, V_{bias}. In many, but not all, cases V_{bias} is significantly larger than V_{dd} which is the DC supply for a transimpedance amplifier (TIA 120) connected to the photodetector 110 and for subsequent amplification stages 122, denoted by gain G in FIG. 1B.

One or more optional gain stages 122 may follow the TIA 120. The last of these may be an inverter 130 which produces a digital output V_{OUT}.

The circuit of FIG. 1B may suffer from errors in the output, V_{OUT}. The source of the problem may be AC noise in the nominally DC power supply V_{dd}. The AC noise causes ripple in the bias point or input threshold of the TIA and other high-gain amplifiers. When the threshold varies, a small signal that should have generated a logical “0” at the inverter output V_{OUT} may instead lead to a “1” output, or vice versa. Such errors may be observed as a partial closing of an eye diagram representing the inverter output.

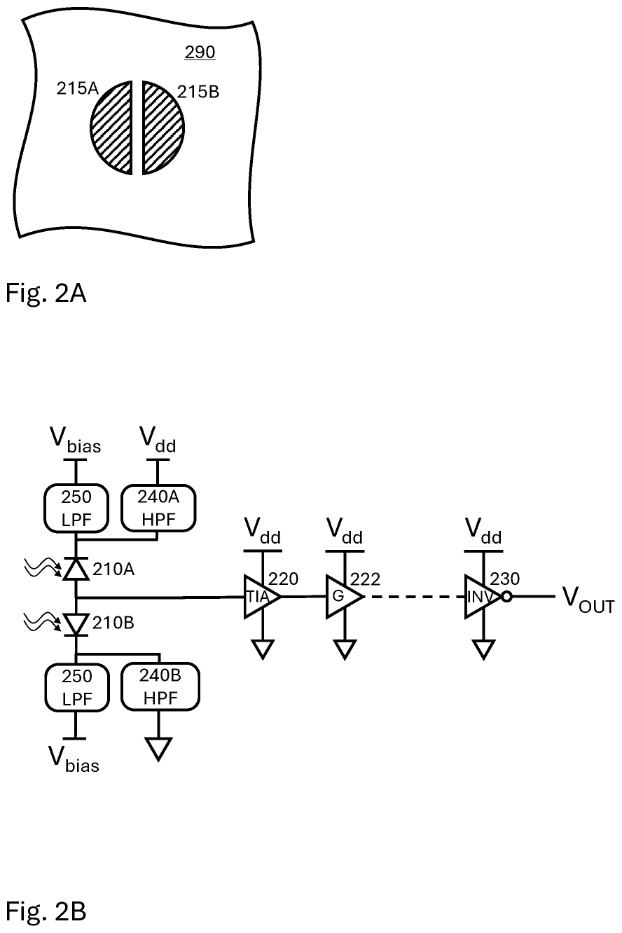

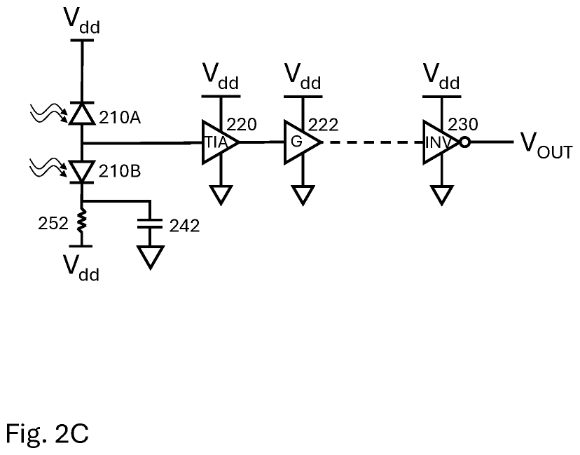

FIG. 2A illustrates a top view of a split photodetector defined on a section of a semiconductor wafer 290. The split photodetector has two (or more) light-sensitive segments 215A, 215B, which are simultaneously illuminated by the incoming optical signal but which produce a combined output (as shown in FIG. 2B). The two segments 215A,B of the photodetector may be equal in size, or their sizes may be different from each other, for example designed to operate in concert with parasitic capacitances in the overall system. A split photodetector may be implemented as separate photodiodes with a combined output, or may have split anodes with a combined cathode, or split cathodes with a combined anode. Alternately, separate PDs together may be used with separate cathodes and anodes, but shown as a single unit since they are in parallel.

FIG. 2B is a simplified schematic diagram for a circuit associated with the split photodetector of FIG. 2A. The split photodetector may be one element of a large array of photodetectors, and the circuit of FIG. 2B may represent one receiver channel among many channels of an optical receiver. The receiver channel receives an optical signal modulated by digital data and recovers the digital data from the received optical signal.

In this example, the split photodetector is based on reverse biased photodiodes 210A,B which are biased by bias supply, V_{bias}. With a negative V_{bias}, the photodetector polarities could be swapped. Each photodiode symbol 210A,B in FIG. 2B represents one of the segments 215A,B in FIG. 2A. A transimpedance amplifier (TIA) 220 is coupled to a combined output of the segments of the split photodiode. The TIA is supplied by a DC voltage source, V_{dd}. This is followed by additional circuitry which recovers a digital output V_{OUT} from the TIA output. In FIG. 2B, the post-TIA receiver circuitry includes an optional chain of additional amplifier stages (G) 222 and an inverter 230 (or other type of comparator).

The DC voltage source, V_{dd}, for the TIA is AC coupled, via high-pass filters 240A,B in FIG. 2B, to the split photodiode. The AC coupling superimposes an AC signal from the DC voltage source V_{dd} on the combined output of the segments. The AC signal may be a scaled version of AC noise in the DC voltage source. Adding the AC signal to the photodiode output reduces the effect of the AC noise.

The areas of the two segments may be selected to adjust the AC signal in order to reduce unwanted effects from the AC noise. The AC signal from V_{dd} has a path to ground through high pass filter 240A, photodiode 210A, photodiode 210B and high pass filter 240B. For purposes of illustration, assume that the capacitance of this AC signal path is dominated by the two photodiodes 210A,B. They then form a capacitive voltage divider for the input to the TIA 220, which can be used to reduce the effect of the AC noise.

Usually, the set point of the various amplifiers (TIA, G, INV) corresponding to the threshold of inverter 230 is V_{dd}/2. If there is 1 mV of ripple in V_{dd}, then 0.5 mV of ripple will be present in the amplifiers' set points. In that case, the capacitive voltage divider should divide the V_{dd} ripple in half at the amplifiers' inputs to match. In order for the input to the TIA 220 to be one half of the AC noise in V_{dd}, the capacitances on both sides of the capacitive voltage divider should be equal. This condition is met when

$$\frac{1}{{C}_{A}} = \frac{1}{{C}_{B}} + \frac{1}{{{C}_{p}}^{′}}$$

where C_{A} is the capacitance of segment 210A/215A, C_{B} is the capacitance of segment 210B/215B, and Cₚ (which could be on either side of the equation) represents the effect of parasitic capacitances in the circuit. The capacitances C_{A}, C_{B} of the segments are proportional to the areas of the segments, which can then be selected to meet the above condition. The parasitic capacitances may be determined by circuit simulation.

This arrangement, with the areas of the segments selected to compensate for V_{dd} noise and parasitic capacitances, injects the same AC noise into the output of the photodiodes 210A,B as appears in the TIA 220 threshold level. Since the two signals move synchronously, small photocurrents are amplified faithfully, and downstream digital errors are reduced. The correlated V_{dd} noise (AC) is injected to match the bias point noise of high-gain amplifiers, thereby reducing errors in digital V_{OUT} level. The high-pass filters 240 may be capacitors or active circuits. The photodiode bias, V_{bias}, is DC coupled, via low-pass filters 250, to the split photodiode. The low-pass filters 250 may be implemented as resistors, inductors or active circuits.

FIG. 2C is a simplified schematic diagram for an alternative circuit associated with the split photodetector of FIG. 2A. In this example, the photodiodes 210A,B are reverse biased by V_{dd}, rather than a separate V_{bias}. V_{dd} is decoupled to ground by a capacitor 242. The resistor 252 and capacitor 242 in FIG. 2C may be replaced by LPF and HPF blocks as in FIG. 2B. The AC noise in V_{dd} has a path to ground via photodiode 210A, photodiode 210B and capacitor 242. This capacitive voltage divider can be used to superimpose a scaled version of the AC noise on the combined output of the split photodiode. The photodetector noise matches the bias point noise of the TIA 220 and downstream amplifiers 222, thereby reducing errors in the inverter digital output V_{OUT}.

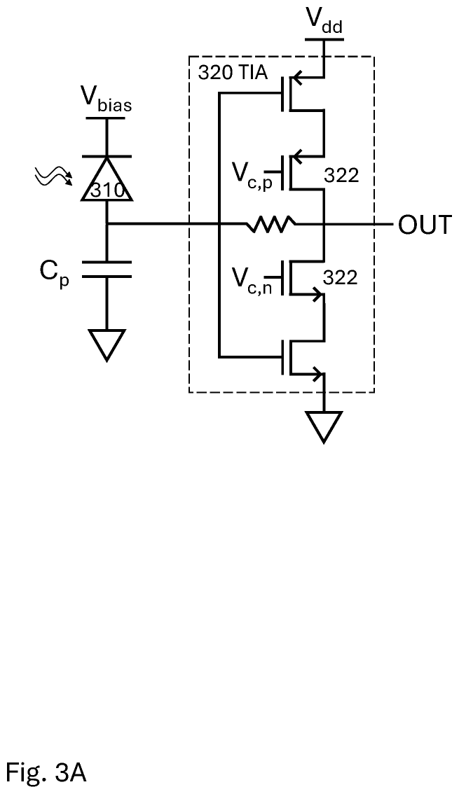

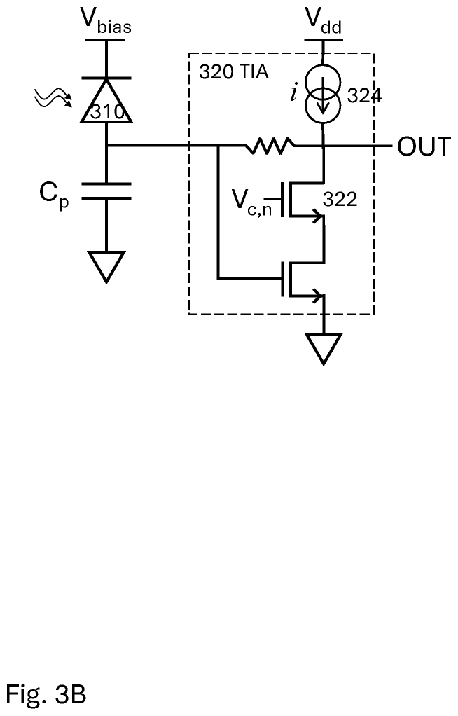

FIGS. 3A and 3B illustrate transimpedance amplifiers suitable for use with the split photodetector circuits described above. FIG. 3A illustrates a photodetector connected to a first implementation of a transimpedance amplifier. In FIG. 3A the parasitic capacitance of the photodetector 310 is represented explicitly as capacitor, Cₚ. The transimpedance amplifier (TIA 320) offers low power consumption, but poor PSRR. AC noise on V_{dd} affects the input threshold of the amplifier which leads to unintended swings in the output. In the TIA, cascode transistors 322, biased by DC voltages V_{c,p} and V_{c,n}, are optional. If included, the cascode transistors 322 significantly increase the output impedance of the circuit and provide peaking in the frequency response which extends the bandwidth for a given power consumption.

FIG. 3B illustrates a photodetector connected to a second implementation of a transimpedance amplifier. In this implementation a current source 324 in the TIA 320 provides improved PSRR compared to the circuit of FIG. 3A; however, this improvement comes at the cost of increased power consumption. In the TIA 320, a cascode transistor 322, biased by DC voltage V_{c,n}, is optional. If included, the cascode transistor significantly increases the output impedance of the circuit and provide peaking in the frequency response which extends the bandwidth for a given power consumption.

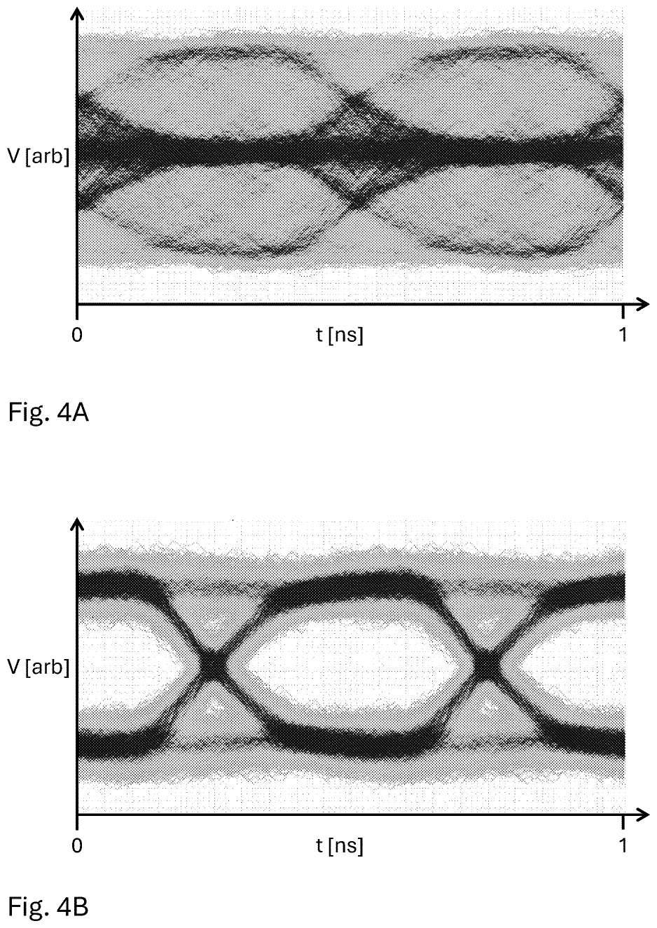

FIG. 4A is an eye-diagram obtained by simulating the single photodetector of FIG. 1A and its associated circuit of FIG. 1B. The simulation spans 2.5 μs of 2 Gbps data using on-off optical modulation. The eye diagram represents the voltage at output of the TIA minus (V_{dd}/2) which is the ideal threshold of the subsequent amplifier, labeled G in FIG. 1B. A 10 mV, 1.087 GHz sine wave is added to V_{dd} to model AC supply ripple.

FIG. 4B is an eye-diagram obtained by simulating the split photodetector of FIG. 2A and its associated circuit of FIG. 2B. As in FIG. 4A, the simulation spans 2.5 μs of 2 Gbps data. The eye diagram represents the voltage at output of the TIA minus (V_{dd}/2) which is the ideal threshold of the subsequent amplifier, labeled G in FIG. 2B. A 10 mV, 1.087 GHz sine wave is added to V_{dd} to model AC supply ripple. Comparison of FIGS. 4A and 4B reveals that the circuit of FIG. 2B offers much greater PSRR than that of FIG. 1B and also produces a more open eye diagram.

The circuits of FIG. 2B and FIG. 2C inject the same AC noise into the photodiodes as appears in the TIA threshold level, thus greatly improving PSRR and reducing noise in high-bandwidth, low-power photodetectors. The AC coupling of V_{dd} to the photodiode reduces unwanted effects caused by AC noise in V_{dd}.

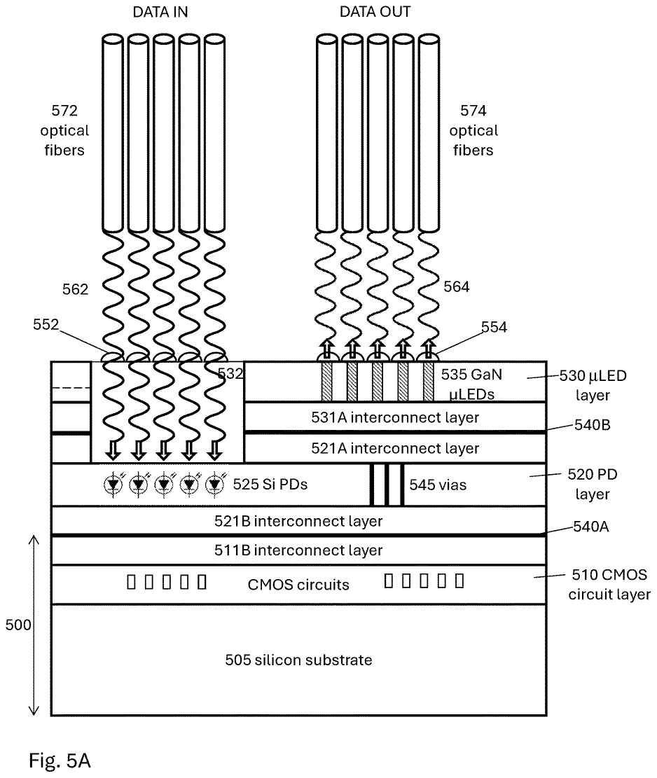

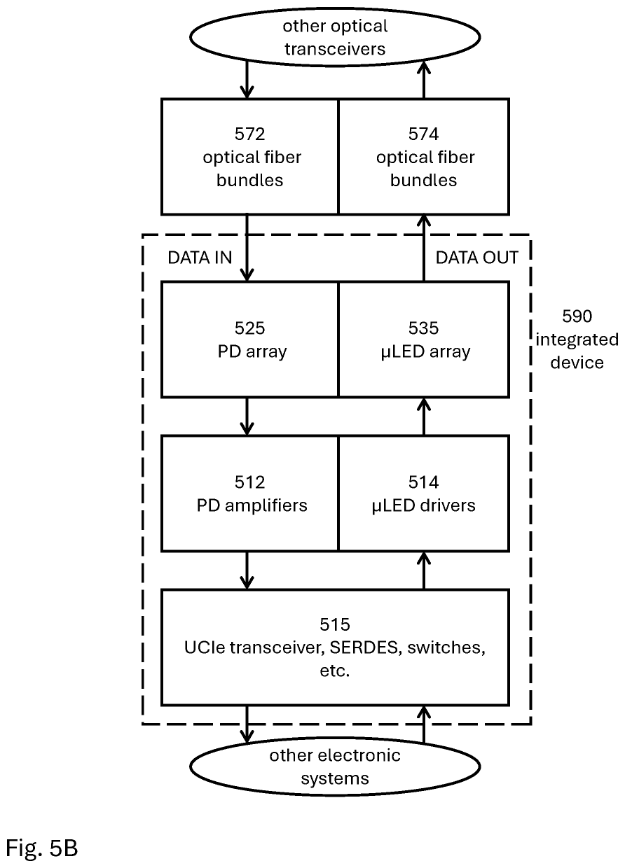

FIG. 5A shows a cross-section of an integrated optical transceiver for chip-to-chip communication, suitable for use with the split photodetectors described above. The transceiver includes a CMOS chip 500, which includes a CMOS circuit layer 510 on a silicon substrate 505. The transceiver also includes a photodetector (PD) layer 520 and a micro-LED (light emitting diode) layer 530. The PD layer 520 includes an array of photodetectors 525, such as the split photodetectors described above. The micro-LED layer 530 includes an array of micro-LEDs 535. The arrays may each include 10,000 or more devices, providing Gb/s data communication capability. In this example, the PD layer 520 is a silicon layer with silicon photodiodes and the micro-LED layer 530 is a GaN layer with GaN quantum well micro-LEDs. Micro-LEDs may be less than 100 μm wide, or less than 50 μm wide, or even less than 10 μm wide. The CMOS circuit layer 510 includes circuits, such as driver circuits for the micro-LEDs and amplifiers for the PDs.

The integrated optical transceiver includes hybrid bonding 540A,B between the different layers 510, 520, 530. In hybrid bonding, an oxide layer on one layer 510, 520, 530 is bonded to an oxide layer on the other layer 510, 520, 530. Metal plugs in the two layers are aligned with one another and slightly recessed, by 1~2 nm for example. Hybrid bonding may be wafer-to-wafer or die-to-wafer. When the dies and/or wafers containing the two layers, adhered by oxide, are heated, the metal plugs expand and fuse together to make electrical connections. Thus, the hybrid bonding 540A,B provides electrical connections between the layers and also mechanically attaches the different layers. More specifically, the hybrid bonding 540A,B provides electrical connections between corresponding interconnect layers 511B-521B and 521A-531A within each of the layers 510, 520, 530.

This example uses a stack of three layers: micro-LED layer 530, PD layer 520 and CMOS circuit layer 510 from top to bottom. The top layer (micro-LED layer 530) is hybrid bonded 540B to the middle layer (PD layer 520), which is hybrid bonded 540A to the bottom layer (CMOS circuit layer 510). The silicon photodiodes 525 are electrically connected to CMOS circuitry (e.g., transimpedance amplifiers) by the hybrid bonding 540A. The micro-LEDs 535 are electrically connected to CMOS circuitry (e.g., drivers) by the hybrid bondings 540A, 540B and vias 545 through the middle layer 520. The vias 545 may be copper damascene structures.

In FIG. 5A, five GaN micro-LEDs 535 are shown, but arrays containing tens, hundreds, thousands or more micro-LEDs may be fabricated. Each micro-LED may have a maximum width of about 0.6 μm to about 5 μm, and the array of micro-LEDs may have a pitch of 50 μm or less. Microlenses 554 (or other optical coupling devices) may couple light from the micro-LEDs 535 into multi-mode optical fibers 574. Each microlens may have a diameter of about 2 μm to about 50 μm. Each multimode optical fiber may have a core diameter of about 10 μm to about 50 μm.

The diameter of the fiber cores may be greater than the diameter of the microlenses. The minimum spatial repetition interval, or pitch, of micro-LEDs in the array may be less than, equal to, or greater than the pitch of the multimode optical fibers.

Similar sizes and numbers may apply to the array of PDs 525, particularly if the data rates are similar in the transmit and receive directions. The PDs may be avalanche photodiode detectors or other types of optical detectors. There may also be different sizes and numbers of micro-LEDs and PDs. In one implementation, the transceiver includes an array of 250,000 micro-LEDs for the optical transmitter and an array of 150,000 PDs for the optical receiver.

The optical transceiver provides an optical transmitter with a data transmit path (DATA OUT), and an optical receiver with a data receive path (DATA IN) as also shown in the block diagram of FIG. 5B. For the optical receiver, the array of Si PDs 525 receives data-encoded light 562 from a bundle of multimode optical fibers 572. Microlenses 552 may be used to couple the light 562 from the optical fibers 572 to the PDs 525, and an aperture 532 in the top micro-LED layer 530 allows propagation of light through the top layer. The aperture 532 may be filled with a thin, transparent fill layer, e.g. of SiO₂, which covers the PDs and planarizes the surface of the structure. The PDs 525 convert the incoming light from optical to electrical form. The CMOS circuit layer 510 contains electronic circuits 512, 515 which receive and demodulate the electrical signals detected by the PDs to recover the digital data encoded on light 562.

For the optical transmitter, the array of GaN micro-LEDs 535 sends data-encoded light 564 to a bundle of multimode optical fibers 574. Microlenses 554 may couple the light from the micro-LEDs 535 to the optical fibers 574. The CMOS circuit layer 510 contains electronic circuits 514, 515 which drive and modulate the micro-LEDs 535 according to digital data received by the transceiver. The CMOS circuit layer 510 may also include a feedback path from the receive path to the transmit path, either for the relay of data from the receive path to the transmit path or for control/processing of the data paths (e.g., equalization).

The components in the dashed box of FIG. 5B may be implemented as an integrated device 590, such as shown in FIG. 5A, or otherwise combined into a single package.

The CMOS chip 500 itself may be a data source providing DATA OUT and/or a data sink consuming DATA IN. Examples include graphics processing units (GPUs) and high-bandwidth memory (HBM). If not, it may be connected to other digital sources and sinks via a high speed digital interface, such as UCle (Universal Chiplet Interconnect Express), PCIe (Peripheral Component Interconnect Express) or CXL (Compute Express Link). Other types of SERDES (serializer/deserializer) interfaces may be used. The digital interface receives digital data from other chips, which the transmit path and micro-LEDs transmit optically as DATA OUT. It transmits digital data to the other chips, which the receive path and PDs recover from the optical DATA IN.

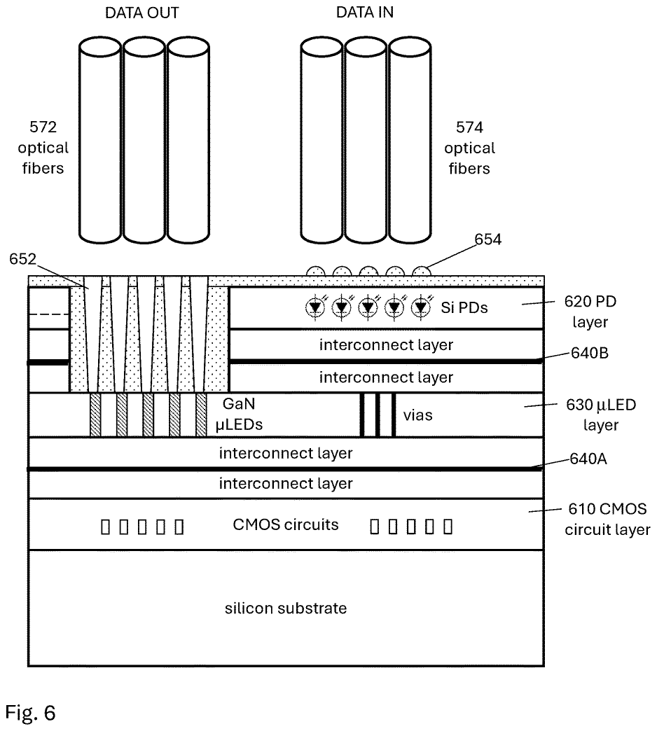

FIG. 6 shows a structure similar to that shown in FIG. 5A. However, in FIG. 6 the GaN micro-LED layer 630 is the middle layer, between the Si PD top layer 620 and the CMOS circuit bottom layer 610. This structure is created by swapping the order of hybrid bonding. First the GaN-on-substrate wafer is hybrid bonded to the CMOS wafer. Next the Si PD wafer is hybrid bonded to the GaN wafer. The window and microlenses over the micro-LEDs is replaced by an array of tapers 652 since more distance is available. Microlenses 654 are used for the PDs. There also is not a one-to-one ratio of optical fibers 572,574 to micro-LEDs/PDs.

Structures similar to the ones described above may also be formed by chip-to-wafer bonding, in addition to wafer-to-wafer bonding. This may be useful in cases where the areas of the micro-LED layer or the PD layer are much smaller than the area of the CMOS chip. Both the PD layer and the micro-LED layer may be hybrid bonded using wafer-to-wafer bonding. Alternatively, one or both layers may be bonded using chip-to-wafer bonding.

Similar permutations are also possible with respect to patterning individual PDs/micro-LEDs. Both the PD layer and the micro-LED layer may be hybrid bonded first and then patterned into individual devices (PDs and micro-LEDs). Alternatively, one or both layers may be patterned into individual devices before hybrid bonding.

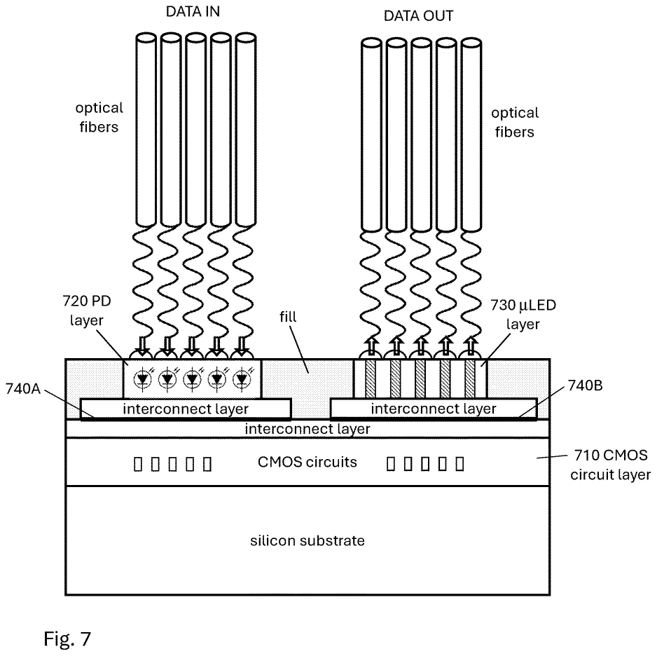

FIG. 7 shows a structure in which both the Si PD layer 720 and the GaN micro-LED layer 730 are hybrid bonded to the CMOS circuit layer 710 by hybrid bondings 740A and 740B, respectively. This structure can have a flat top surface. The distance to the optical fibers is approximately the same for both PDs and micro-LEDs, which simplifies the optical design for microlenses, lightguide tapers or other optical coupling devices. Another advantage is that electrical connections can be shorter. For example, both the PDs and the micro-LEDs are connected directly to the CMOS circuits, without requiring vias to traverse through intermediate layers. In both the two-layer and three-layer stacks, both the thickness from the top of the PD layer to the top of the CMOS circuit layer and from the top of the micro-LED layer to the top of the CMOS circuit layer may be 20 μm or less, resulting in shorter connections and lower capacitance.

The structure of FIG. 7 may be fabricated by using chip-to-wafer bonding. The wafers containing the PD layer and/or micro-LED layer may be diced into individual dies, and then these are hybrid bonded to the CMOS wafer. Chip-to-wafer bonding can also be used to fabricate any of the three-layer stacks described above.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A circuit comprising:
a split photodiode comprising two segments with a single combined output;
a transimpedance amplifier (TIA) coupled to the combined output of the segments, the TIA supplied by a DC voltage source; and
an AC coupling of the DC voltage source to the split photodiode, wherein the AC coupling superimposes an AC signal from the DC voltage source on the combined output of the segments.

2. The circuit of claim 1 where the DC voltage source contains AC noise that affects operation of the TIA, and the AC signal superimposed on the combined output of the segments reduces the effect of the AC noise.

3. The circuit of claim 2 where the areas of the two segments are based on reducing the effect of the AC noise.

4. The circuit of claim 2 where the AC coupling comprises capacitive coupling that provides a capacitive voltage divider that divides the AC noise and superimposes the divided AC noise on the combined output of the segments.

5. The circuit of claim 1 where the two segments have different areas.

6. The circuit of claim 1 where the areas of the two segments are based on parasitic capacitances in the system.

7. The circuit of claim 1 where the segments are reverse biased by a bias source different than the DC voltage source.

8. The circuit of claim 1 where the segments are reverse biased by the DC voltage source.

9. The circuit of claim 1 where the AC coupling comprises capacitive coupling.

10. The circuit of claim 1 where the split photodiode comprises one of: two segments with separate anodes and separate cathodes, two segments with separate anodes and a combined cathode, or two segments with a combined anode and separate cathodes.

11. An optical receiver comprising a plurality of receiver channels in a single package, each receiver channel comprising:
a split photodiode comprising two segments with a single combined output;
a transimpedance amplifier (TIA) coupled to the combined output of the segments, the TIA supplied by a DC voltage source;
an AC coupling of the DC voltage source to the split photodiode, wherein the AC coupling superimposes an AC signal from the DC voltage source on the combined output of the segments; and
post-TIA receiver circuitry coupled to the TIA, where the post-TIA receiver circuitry recovers digital data from an output of the TIA.

12. The optical receiver of claim 11 where the DC voltage source contains AC noise that closes an eye diagram of the receiver channel, and the AC coupling opens the eye diagram in the presence of the AC noise.

13. The optical receiver of claim 11 where a digitally modulated optical signal simultaneously illuminates both segments of the split photodiode.

14. The optical receiver of claim 11 where the receiver circuitry comprises:
a comparator coupled to the TIA; where the comparator produces a digital output by comparing a received input signal to a threshold, AC noise in the DC voltage source causes errors in the comparison; and the AC signal reduces the errors.

15. The optical receiver of claim 11 where the digitally modulated optical signal is an on-off modulated optical signal.

16. The optical receiver of claim 11 where the receiver circuitry comprises:
a chain of one or more additional amplifiers coupled to the output of the TIA; and
an inverter coupled to the chain of amplifiers, the inverter producing a digital output.

17. The optical receiver of claim 11 where the split photodiode and TIA are integrated on a single semiconductor die.

18. The optical receiver of claim 11 where the split photodiode and TIA are hybrid bonded to each other.

19. The optical receiver of claim 11 comprising an array of at least 10,000 split photodiodes, where the plurality of receiver channels provide Gb/s data communication capability.

20. An optical interconnect comprising:
an optical transmitter that receives digital data and produces an optical signal modulated by the digital data, an optical receiver that recovers the digital data from the optical signal, and an optical fiber link that transports the optical signal from the optical transmitter to the optical receiver;
where the optical receiver comprises:
a split photodiode comprising two segments with a single combined output;
a transimpedance amplifier (TIA) coupled to the combined output of the segments, the TIA supplied by a DC voltage source;
an AC coupling of the DC voltage source to the split photodiode, wherein the AC coupling superimposes an AC signal from the DC voltage source on the combined output of the segments; and
post-TIA receiver circuitry coupled to the TIA, where the post-TIA receiver circuitry recovers digital data from an output of the TIA.
